(19) United States
(12) Patent Application Publication
(10) Pub. No.: US 2008/0266329 A1
(43) Pub. Date: Oct. 30, 2008

(54) MULTI-COLOR DISPLAY DEVICE AND DRIVING METHOD THEREOF

(75) Inventors: Kyong-Tae PARK, Suwon-si (KR); Beohm-Rock CHOI, Seoul (KR); Young-Rok SONG, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/933,012

(22) Filed: Oct. 31, 2007

(30) Foreign Application Priority Data
Apr. 25, 2007 (KR) 10-2007-0040455

(51) Int. Cl. G09G 5/10; G09G 3/30

(52) U.S. Cl. 345/690; 345/80

(57) ABSTRACT

A display device includes; a plurality of pixels which individually display one of a first color, a second color, a third color, and white, a signal processor which receives input image signals corresponding to the first to third colors, modifies color temperatures represented by the input image signals, compensates luminances of the input image signals, and converts the input image signals corresponding to the first to third colors into output image signals corresponding to the first to third colors and white as a result of the modification and compensation, and a data driver which converts the output image signals into data voltages and supplies the data voltages to the pixels.

This application claims priority to Korean Patent Application No. 10-2007-0040455, filed on Apr. 25, 2007, and all the benefits accruing therefrom under 35 U.S.C. §119, the contents of which in its entirety are herein incorporated by reference.

### BACKGROUND OF THE INVENTION

(a) Field of the Invention

The present invention relates to a display device and a driving method thereof.

(b) Description of the Related Art

Recently, flat panel displays have become increasingly popular. The flat panel displays include a plurality of pixels arranged in a matrix form with each pixel representing one of three primary colors, wherein the primary colors are typically red, green and blue. Display output color is determined by combining the three primary colors emitted from at least three pixels, and the flat panel displays can display desired images by appropriately controlling a luminance of each colored pixel. The primary colors may be combined to form a white light.

However, when an image is displayed with only three pixels for the three primary colors, light efficiency may be deficient for a high quality display. Particularly, in organic light emitting diode (“OLED”) devices, light emitting efficiency of an emission layer may vary widely according to the color of light produced in that emission layer.

Accordingly, a technology adding a pixel which emits white light in addition to the pixels which emit the three primary color pixels has been suggested.

Such a four color display device having the white pixels and the three primary color pixels receives input image signals for the three primary color pixels, for example, three pixels one each for red, green and blue colors, to generate output image signals for the red, green, blue and white pixels.

Meanwhile, in the four color display device, a color coordinate and a luminance of a white light represented by a white pixel may be different from those of a white light represented by synthesization of the red, green and blue pixels. In addition, a difference between the two white lights, e.g., the synthesized white light and the white light from the white light emitting pixel, causes distortion of a color distribution of the resulting display.

### BRIEF SUMMARY OF THE INVENTION

According to an exemplary embodiment of the present invention, a display device includes a plurality of pixels which individually display one of a first color, a second color, a third color, and white, a signal processor which receives input image signals corresponding to the first to third colors, modifies color temperatures represented by the input image signals, and compensates luminances of the input image signals and converts the input image signals corresponding to the first to third colors into output image signals corresponding to the first to third colors and white as a result of the modification and compensation, and a data driver which converts the output image signals into data voltages and supplies the data voltages to the pixels.

In one exemplary embodiment the signal processor includes a processing unit which generates preliminary luminance signals corresponding to the first to third colors, and white based on the input image signals, a modifier which modifies the preliminary luminance signals based on a color modification value and generates modification luminance signals, and a de-gamma converter which outputs the output image signals based on the modification luminance signals.

In one exemplary embodiment the luminance compensation value may be defined by a luminance compensation variable, and wherein the luminance compensation variable is determined by the number of modification luminance signals of a previous frame having a luminance more than or equal to a maximum luminance of the display device.

In one exemplary embodiment when the number of modification luminance signals of a previous frame having a luminance more than or equal to a maximum luminance of the display device is within a predetermined range having an upper limit and a lower limit, the luminance compensation variable may maintain a luminance compensation variable of the previous frame, wherein when the number of modification luminance signals of a previous frame having a luminance more than or equal to a maximum luminance of the display device is more than the upper limit, the luminance compensation variable may be determined as a value obtained by subtracting a predetermined value from the luminance compensation variable of the previous frame, and wherein when the number of modification luminance signals of a previous frame having a luminance more than or equal to a maximum luminance of the display device is less than the lower limit, the luminance compensation variable may be determined as a value obtained by adding the predetermined value to the luminance compensation variable of the previous frame.

In one exemplary embodiment the modification luminance signals may satisfy the equation below:

$$( \begin{matrix}a + s & 0 & 0 & 0 \\ 0 & b + s & 0 & 0 \\ 0 & 0 & c + s & 0 \\ 0 & 0 & 0 & d + s\end{matrix} ) ( \begin{matrix}L R \\ L G \\ L B \\ L W\end{matrix} ) = ( \begin{matrix}L {P}^{′} \\ L {G}^{′} \\ L {B}^{′} \\ L {W}^{′}\end{matrix} )$$

wherein, a, b, c, and d are color modification constants of the first to third colors and white, and the character s is the luminance compensation variable, LR, LG, LB, and LW are preliminary luminance signals of the first to third colors and white, and LR′, LG′, LB′, and LW′ are modification luminance signals of the first to third colors, and white.

In one exemplary embodiment a value obtained by adding the luminance compensation variable and the color modification constant of white may be less than or equal to 1.

In one exemplary embodiment the signal processor may define a luminance of the preliminary luminance signal of white based on luminances of the input image signals, and determines luminances of the preliminary luminance signals of the first to third colors in accordance with the luminance of the preliminary luminance signal of white.

In one exemplary embodiment the luminance of the preliminary luminance signal of white may be substantially equal to a minimum luminance value of the input image signals, and luminances of the preliminary luminance signals of the first to third colors may be defined as values obtained by subtracting the luminance of the preliminary luminance signal of white from the luminances of the input image signals, respectively.

In one exemplary embodiment the signal processor may de-gamma covert the modification luminance signals to generate the output image signals, and the signal processor may define the luminances of the modification luminance signals as a maximum luminance of the display device when the luminances of the modification luminance signals are greater than the maximum luminance of the display device, before the de-gamma conversion of the modification luminance signals.

In one exemplary embodiment each of the pixels may comprise an organic light emitting element.

In one exemplary embodiment the first to third colors may be three primary colors.

According to another exemplary embodiment of the present invention, a method of driving a display device includes; receiving red, green and blue input image signals, generating preliminary luminance signals based on the input image signals, modifying color temperatures of the preliminary luminance signals, compensating luminances of the preliminary luminance signals to generate modification luminance signals of red, green, blue and white, and generating output image signals of red, green, blue and white based on the modification luminance signals, wherein the luminance compensation of the preliminary luminance signals is performed based on the number of modification luminance signals of a previous frame having a luminance more than or equal to a maximum luminance of the display device.

In one exemplary embodiment the preliminary luminance signal generation may include; aligning the input image signals sequentially from the input image signal having a largest magnitude gray voltage level to the input image signal having a smallest magnitude gray voltage level to generate first, second, and third signals, respectively, defining the preliminary luminance signal of white to be substantially equal to a luminance corresponding to the third signal, and modifying the input image signals based on the preliminary luminance signal of white to generate preliminary luminance signals of red, green and blue.

In one exemplary embodiment the luminance compensation may be defined by a luminance compensation variable, and when the number of modification luminance signals of a previous frame having a luminance more than or equal to a maximum luminance of the display device is within a predetermined range having an upper limit and a lower limit, the luminance compensation variable may maintain a luminance compensation variable of the previous frame, and when the number of modification luminance signals of a previous frame having more than or equal to a maximum luminance of the display device is more than the upper limit, the luminance compensation variable may be determined as a value obtained by subtracting a predetermined value from the luminance compensation variable of the previous frame, and when the number of modification luminance signals of a previous frame having a luminance more than or equal to a maximum luminance of the display device is less than the lower limit, the luminance compensation variable may be determined as a value obtained by adding the predetermined value to the luminance compensation variable of the previous frame.

In another exemplary embodiment a method of driving a display device includes; receiving red, green and blue input image signals, generating preliminary luminance signals based on the input image signals, modifying color temperatures of the preliminary luminance signals to generate modification luminance signals of red, green, blue, and white, and generating output image signals of red, green, blue and white based on the modification luminance signals.

### BRIEF DESCRIPTION OF THE DRAWINGS

The present invention will become more apparent by describing exemplary embodiments thereof in detail with reference to the accompanying drawings in which:

FIG. 1 is a block diagram of an exemplary embodiment of an organic light emitting diode (“OLED”) display according to the present invention;

FIG. 2 is an equivalent circuit diagram of an exemplary embodiment of a pixel of an OLED display according to the present invention;

FIG. 3 shows an exemplary embodiment of an arrangement of pixels of an OLED display according to the present invention;

FIG. 4 is a block diagram of an exemplary embodiment of a signal processor according to the present invention;

FIG. 5 is a block diagram of an exemplary embodiment of a signal processor according to the present invention;

FIG. 6 is a graph showing an exemplary embodiment of a chromaticity diagram;

FIG. 7 is a graph showing color distribution according to a comparative example of a display; and

FIG. 8 is a graph showing color distribution according to an exemplary embodiment of the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

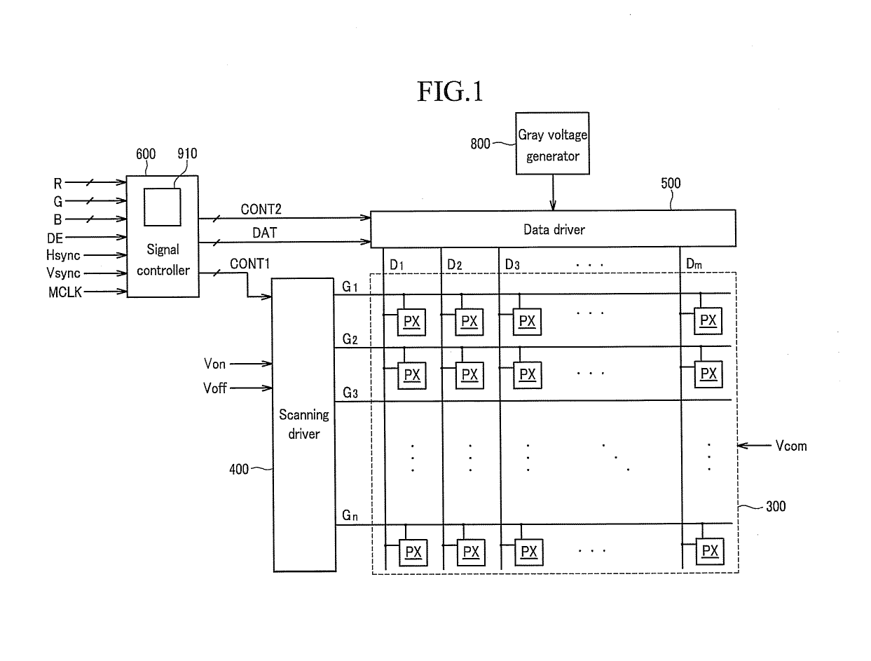

An exemplary embodiment of an organic light emitting diode (“OLED”) display will be described with reference to FIGS. 1 to 3.

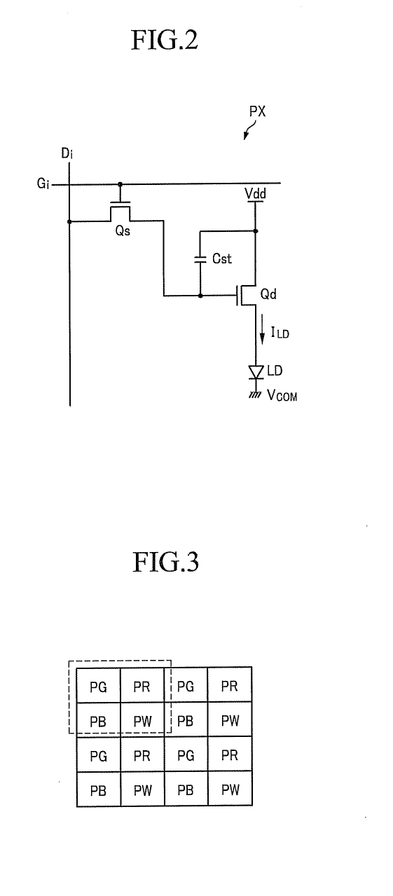

FIG. 1 is a block diagram of an exemplary embodiment of an OLED display according to the present invention, FIG. 2 is an equivalent circuit diagram of an exemplary embodiment of a pixel of an OLED display according to the present invention, and FIG. 3 shows an exemplary embodiment of pixel arrangements of an exemplary embodiment of an OLED display according to the present invention.

Referring to FIG. 1, an exemplary embodiment of an OLED according to the present invention includes a display panel 300, a scanning driver 400 and a data driver 500 which are connected to the display panel 300, a gray voltage generator 800 coupled to the data driver 500, and a signal controller 600 which controls the above elements.

The display panel 300 includes a plurality of signal lines G₁-Gₙ and D₁-Dₘ, a plurality of voltage lines (not shown), and a plurality of pixels PX connected to the signal lines G₁-Gₙ and D₁-Dₘ and the voltage lines and arranged substantially in a matrix. An equivalent circuit view of an exemplary embodiment of an individual pixel of the plurality of pixels is shown in FIG. 2

The signal lines G₁-Gₙ and D₁-Dₘ include a plurality of scanning lines G₁-Gₙ for transmitting scanning signals and a plurality of data lines D₁-Dₘ for transmitting data signals. The scanning lines G₁-Gₙ extend substantially in a row direction and are substantially parallel to each other, while the data lines D₁-Dₘ extend substantially in a column direction and are substantially parallel to each other.

Referring to FIG. 2, each of the pixels PX, for example, a pixel PX in an i-th row (i=1, 2, . . . , n) and a j-th column (j=1, 2, . . . , m), is connected to a scanning line Gᵢ and a data line Dⱼ and includes an organic light emitting element LD, a driving transistor Qd, a capacitor Cst, and a switching transistor Qs.

The switching transistor Qs, which in one exemplary embodiment may be a thin film transistor (“TFT”), has three terminals including; a control terminal connected to a scanning line Gᵢ, an input terminal connected to the data line Dⱼ, and an output terminal connected to the driving transistor Qd. The switching transistor Qs transmits a data voltage in response to a scanning signal applied to the scanning line Gᵢ.

The driving transistor Qd, which in one exemplary embodiment may be a TFT, also has three terminals including; a control terminal connected to the output terminal of the switching transistor Qs, an input terminal connected to a driving voltage Vdd, and an output terminal connected to the organic light emitting element LD. The driving transistor Qd allows an output current I_{LD}, having a magnitude defined based on a voltage between the control terminal and the input terminal, to flow between the input terminal and the output terminal.

The capacitor Cst is connected between the control terminal and the input terminal of the driving transistor Qd. The capacitor Cst charges the data voltage applied to the control terminal of the driving transistor Qd through the switching transistor Qs and maintains the data voltage after the switching transistor Qs is turned off.

In one exemplary embodiment the organic light emitting element LD may be an OLED, and the organic light emitting element LD has an anode connected to the output terminal of the driving transistor Qd and a cathode connected to a common voltage Vcom. The organic light emitting element LD emits light having an intensity corresponding to the output current I_{LD} of the driving transistor Qd. In one exemplary embodiment the organic light emitting element LD uniquely represents a single primary color or a white color. In one exemplary embodiment the primary colors include red, green and blue. In one exemplary embodiment a spatial sum of the primary colors represents a desired color. By adding white light to the synthesized light, the total luminance of the color may be increased.

In an alternative exemplary embodiment, substantially all of the organic light emitting elements LD of all of the pixels PX may emit white light. In such an exemplary embodiment, some pixels PX may further include a color filter (not shown) which changes white light emitting from the organic light emitting element LD to one of the primary color lights.

Referring to FIG. 3, the pixels PX for emitting light of red, green, blue and white colors are referred to as a red pixel PR, a green pixel PG, a blue pixel PB, and a white pixel PW, respectively, and are arranged in a 4×4 matrix. A pixel set which is arranged in this way is referred to as a “dot.” In one exemplary embodiment the OLED display has a structure in which the dots are repeatedly disposed in a row direction and a column direction.

In one exemplary embodiment, the red pixel PR is disposed opposite to the blue pixel PB in a diagonal direction, and the green pixel PG is opposite to the white pixel PW in a diagonal direction in each dot. This structure, in which a green pixel PG and a white pixel PW face each other in the diagonal direction, produces an OLED display with good color characteristics.

Alternative exemplary embodiments include configurations wherein the four color pixels PR, PG, PB, and PW may have a stripe arrangement or a pentile arrangement in addition to the exemplary embodiment of a checkered pattern arrangement shown in FIG. 3.

In one exemplary embodiment the switching transistor Qs and the driving transistor Qd are n-channel field effect transistors (“FETs”) including amorphous silicon or polysilicon. However, alternative exemplary embodiments include configurations wherein at least one of the transistors Qs and Qd may be a p-channel FET operating in a manner opposite to n-channel FETs. In addition, alternative exemplary embodiments include configurations wherein the connections of the transistors Qs and Qd, the capacitor Cst, and the organic light emitting element LD may be varied.

Referring to FIG.1 again, the scanning driver 400 is connected to the scanning lines G₁-Gₙ of the display panel 300, and synthesizes a high voltage Von for turning on the switching transistors Qs and a low voltage Voff for turning off the switching transistors Qs to generate scanning signals for application to the scanning lines G₁-Gₙ.

The data driver 500 is connected to the data lines D₁-Dₘ of the display panel 300 and applies data voltages to the data lines D₁-Dₘ.

The gray voltage generator 800 generates a plurality of gray voltage sets to output to the data driver 500, wherein each gray voltage set includes a plurality of voltages of varying magnitude. In one exemplary embodiment a different gray voltage set may be applied for each color pixel, e.g., PR, PG, PB and PW. In such an exemplary embodiment, the plurality of voltages in the different gray voltage sets may be selected with consideration to the light emitting efficiency and lifetime of a light emitting material.

The signal controller 600 controls the scanning driver 400, the data driver 500, and other similar elements.

In one exemplary embodiment the signal controller 600 includes a signal processor 910 which generates four color output image signals R′, G′, B′, and W′ from three color input image signals R, G, and B. The signal processor 910 will be described in more detail below.

In one exemplary embodiment, each of the driving elements 400, 500, 600, and 800 may include at least one integrated circuit (“IC”) chip which may be mounted on the LC panel assembly 300 itself or on a flexible printed circuit (“FPC”) film as a tape carrier package (“TCP”), which is then attached to the panel assembly 300. Alternative exemplary embodiments include configurations wherein at least one of the units 400, 500, 600, 700, and 800 may be integrated with the display panel 300 along with the signal lines G₁-Gₙ, D₁-Dₘ and the transistors Qs and Qd. In a further alternative exemplary embodiment all the driving elements 400, 500, 600, and 800 may be integrated into a single IC chip. In another version of such an alternative exemplary embodiment at least one of the units 400, 500, 600, and 800 or at least one circuit element of at least one of the units 400, 500, 600, and 800 may be disposed outside of the single IC chip.

An operation of the OLED display will now be described.

The signal controller 600 is supplied with input image signals R, G, and B of three colors such as red, green and blue, and input control signals for controlling the display thereof from an external graphics controller (not shown). The input image signals R, G, and B are digital signals having a gray value corresponding to luminance of each pixel PX. The number of grays available to be output as gray values may be, for example 1024 (=2¹⁰), 256 (=2⁸), or 64 (=2⁶). The gray values correspond to a gray voltage level to be sent as a data signal through the data lines D₁-Dₘ. A luminance represented by each gray is defined by a gamma curve of the display device, and converting the input image signals R, G, and B or the grays to luminances is called “a gamma conversion”.

In one exemplary embodiment the input control signals include a vertical synchronization signal Vsync, a horizontal synchronization signal Hsync, a main clock signal MCLK, a data enable signal DE, and various other similar signals.

After extracting preliminary image signals of red, green, blue and white from the input image signals R, G, and B of the three colors and modifying the preliminary input image signals, the signal controller 600 processes the preliminary input image signals to be suitable for the operation of the display panel 300 to generate processed output image signals R′, G′, B′, and W′ of red, green, blue and white, respectively. The process of extracting the preliminary image signals from the input image signals and modifying the preliminary input image signals will be discussed in more detail below.

The signal controller 600 also generates scanning control signals CONT1 and data control signals CONT2 and transmits the scanning control signals CONT1 to the scanning driver 400 and the data control signals CONT2 and the processed output image signals R′, G′, B′, and W′ to the data driver 500.

In one exemplary embodiment the scanning control signals CONT1 include a scanning start signal STV for instructing to start scanning and at least one clock signal for controlling the output time of the high voltage Von. In another exemplary embodiment the scanning control signals CONT1 may further include an output enable signal OE for defining the duration of the high voltage Von.

In one exemplary embodiment the data control signals CONT2 include a horizontal synchronization start signal STH for informing of start of transmission of the processed output image signals R′, G′, B′, and W′ for a row of pixels PX, a load signal LOAD for instructing to apply the data voltages to the data lines D₁-Dₘ, and a data clock signal HCLK.

Responsive to the data control signals CONT2 from the signal controller 600, the data driver 500 receives a packet of the processed output image signals R′, G′, B′, and W′ for the row of pixels PX, and converts the digital processed output image signals R′, G′, B′, and W′ into analog data voltages.

The scanning driver 400 applies the high voltage Von to a scanning line G₁-Gₙ in response to the gate control signals CONT1 from the signal controller 600, thereby turning on the switching transistors Qs connected to the scanning line G₁-Gₙ.

Accordingly, the switching transistors Qs of the corresponding pixel row are turned on and the driving transistors Qd receive the corresponding data voltages through the turned-on switching transistors Qs. Each driving transistor Qd outputs a driving current I_{LD} corresponding to the applied data voltage to the organic light emitting element LD. Accordingly, the organic light emitting element LD emits light of a luminosity corresponding to the magnitude of the driving current I_{LD}.

By repeating the process with a unit of one horizontal period (which is also referred to as “1H”, and is equal to one period of a horizontal synchronizing signal Hsync and a data enable signal DE), all of the scanning lines G₁-Gₙ are sequentially supplied with the high voltage Von, thereby applying the voltages to all pixels PX to display an image. This image is referred to as a single frame. In order to display moving images, a series of frames may be rapidly displayed. A viewer then interprets the rapidly displayed frames as motion.

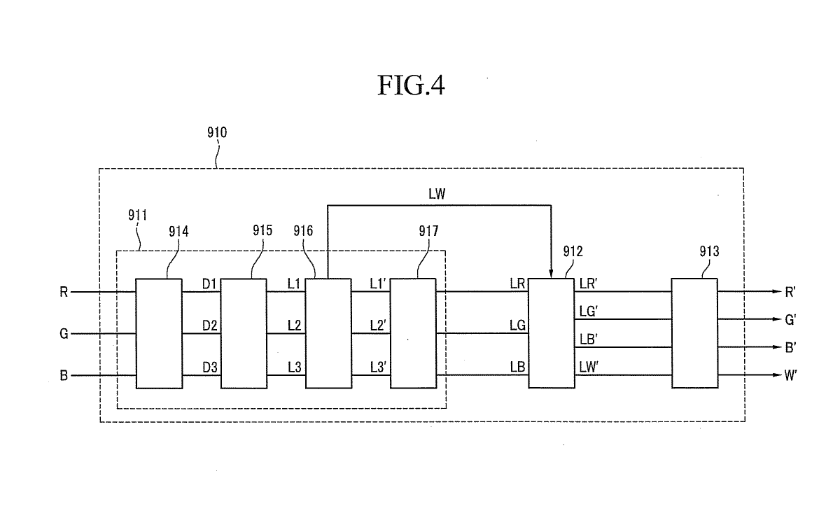

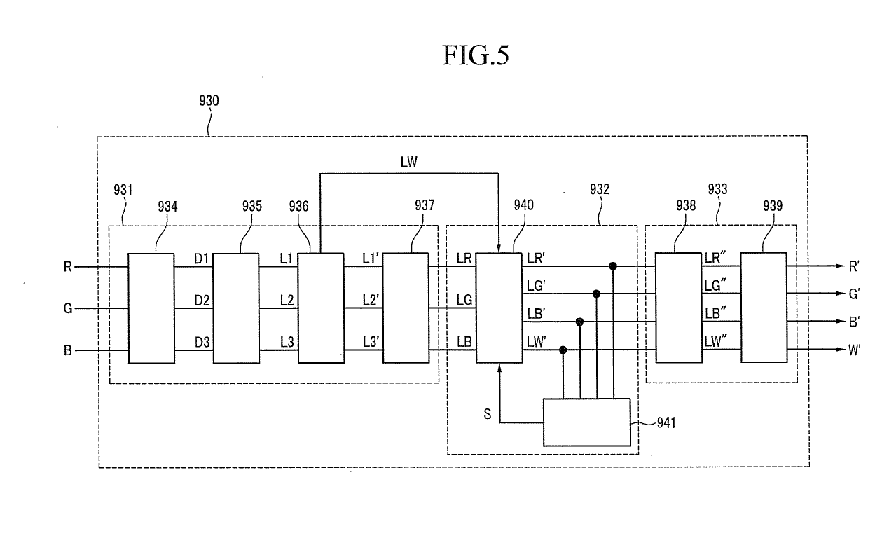

Next, referring to FIG. 4, an exemplary embodiment of the signal processor 910 according to the present invention will be described.

FIG. 4 is a block diagram of an exemplary embodiment of a signal processor according to the present invention.

The exemplary embodiment of an OLED display according to the present invention includes the exemplary embodiment of a signal processor 910, as described above.

Referring to FIG. 4, the exemplary embodiment of a signal processor 910 includes a processing unit 911, a modifier 912, and a de-gamma converter 913.

The signal processor 910 is supplied with a plurality of groups of three color input image signals R, G, and B from an external device and generates four processed color output image signals R′, G′, B′, and W′ corresponding to red, green, blue and white, respectively. The processing unit 911 includes a first signal ordering unit 914, a gamma converter 915, a calculator 916, and a second signal ordering unit 917. The processing unit 911 is supplied with a plurality of groups of color input image signals, each group including three color input image signals, R, G, and B. The processing unit 911 generates preliminary luminance signals (referred to as “four color preliminary luminance signals”) LR, LG, LB, LW corresponding to red, green, blue and white, respectively, from the three color input image signals R, G. and B of each group.

The first signal ordering unit 914 is supplied with the plurality of groups of three color input image signals R, G, and B and arranges the three color input image signals R, G, and B based on gray levels thereof. In one exemplary embodiment the arrangement order may be in order of magnitude of the grays of the respective input image signals R. G, and B, e.g., in one exemplary embodiment the three color input image signals may be arranged in order of descending gray voltage level.

When the three color input image signals R, G, and B are arranged in order of descending gray voltage level, it is assumed that a first signal D1, a second signal D2, and a third signal D3 are sequentially defined from the input image signal having the largest gray voltage level to the input image signal having the smallest gray voltage level of the three color input image signals R, G, and B. In addition, gray voltage levels of the first, second, and third signals D1-D3 are sequentially referred to as a first gray, a second gray, and a third gray.

The gamma converter 915 gamma-converts the first to third signals D1-D3 to generate first to third luminance signals L1, L2, and L3, respectively. The luminance signals L1-L3 have a first luminance, a second luminance, and a third luminance corresponding to the first to third grays, respectively.

The calculator 916 generates a white preliminary luminance signal LW based on the first to third luminance signals L1-L3, and converts the first to third luminance signals L1-L3 to first to third base luminance signals L1′, L2′, and L3′, respectively.

In one exemplary embodiment the calculator 916 may define a luminance of the third luminance signal L3, which has the smallest luminance of the first to third luminance signals L1-L3, as a luminance of the white preliminary luminance signal LW, and may define that the first to third base luminance signals L1′, L2′, and L3′0 have a luminance obtained by subtracting the luminance of the white preliminary luminance signal LW, which in this exemplary embodiment is the same as the third luminance, from the first to third luminances of the first to third luminance signals L1-L3, respectively. Thereby, the first base luminance signal L1′ may have a value obtained by subtracting the third luminance from the first luminance, the second base luminance signal L2′ may have a value obtained by subtracting the third luminance from the second luminance, and the third base luminance signal L3′ may be 0.

The second signal ordering unit 917 rearranges the first to third base luminance signals L1′-L3′ in accordance with color information, and defines the rearranged base luminance signals L1′-L3′ as preliminary luminance signals (referred to as “three color preliminary luminance signals”) LR, LG, and LB corresponding to red, green and blue, respectively. In the present exemplary embodiment the rearrangement order of the output gray signals L1′-L3′ is red, green and blue. Alternative exemplary embodiments include configurations wherein the rearrangement order is varied.

Next, the modifier 912 receives the three preliminary luminance signals LR, LG, and LB and the white preliminary luminance signal LW (referred to as “four color preliminary luminance signals”) from the processing unit 911 and modifies color temperature of the preliminary luminance signals LR, LG, LB, and LW to convert the preliminary luminance signals LR, LG, LB, and LW into modification luminance signals (referred to as “four color modification luminance signals”) LR′, LG′, LB′, and LW′, respectively.

In the present exemplary embodiment, the modifier 912 performs an operation based on Equation 1 as below.

$$( \begin{matrix}a & 0 & 0 & 0 \\ 0 & b & 0 & 0 \\ 0 & 0 & c & 0 \\ 0 & 0 & 0 & d\end{matrix} ) ( \begin{matrix}L R \\ L G \\ L B \\ L W\end{matrix} ) = ( \begin{matrix}L {P}^{′} \\ L {G}^{′} \\ L {B}^{′} \\ L {W}^{′}\end{matrix} ) \qquad ( Equation 1 )$$

In Equation 1, the characters a, b, c, and d are color modification constants of red, green, blue and white, respectively. The color modification constants a, b, c, and d are used for reducing color distribution distortion due to color temperature and luminance differences between white generated by a white pixel PW (also referred to as “pixel white”) and white represented by synthesization of three pixels of a red pixel PR, a green pixel PG, and a blue pixel PB (also referred to as ” synthesization white”). The color modification constants a, b, c, and d may be varied in accordance with characteristics of the material which constitutes the organic light emitting element LD.

Thereby, the color modification constants a, b, c, and d modify the output image signals of the red, green and blue pixels PR, PG, and PB which constitute the synthesization white on the basis of a color coordinate of the pixel white. This allows the synthesization white and the pixel white to attain substantially the same color coordinate without having to vary the color coordinate of the pixel white. Accordingly, the color modification constants a, b, c, and d have values to adjust the color coordinate difference and the luminance difference of the pixel white and the synthesization white, respectively. In one exemplary embodiment the values of the color modification constants a, b, c, and d may be less than 1.

When the input image signals R, G, and B of red, green and blue have the same luminance, the color modification constants a, b, c, and d are determined to make the color coordinate and the luminance of the pixel white equal to those of the synthesization white; e.g., when the input image signals R, G, and B have luminances of (10, 10, 10), respectively, the color modification constants a, b, c, and d are determined such that the color coordinate and the luminance of the pixel white represented by (10×d) are the same as those of the synthesization white represented by (10×a, 10×b, 10×c).

The de-gamma converter 913 de-gamma coverts the four color modification luminance signals LR′, LG′, LB′, and LW′ to generate the output image signals (referred to as four color output image signals”) R′, G′, B′, and W′ corresponding to red, green, blue and white, respectively.

Next, referring to FIG. 5, another exemplary embodiment of a signal processor according to the present invention will be described.

FIG. 5 is a block diagram of another exemplary embodiment of a signal processor according to the present invention.

Referring to FIG. 5, a signal processor 930 of this exemplary embodiment has a structure substantially similar to that of the signal processor 910 shown in FIG. 4. That is, the signal processor 930 of this exemplary embodiment includes a first processing unit 931 and a modifier 932. However the signal processor 930 further includes a second processing unit 933 The signal processor 930 receives three color input image signals R, G, and B, modifies color temperatures of the input image signals R, G, and B, and compensates the luminances of the input image signals R. G, and B, respectively, to generate four color output image signals R′, G′, B′, and W′ corresponding to red, green, blue and white, respectively.

The first processing unit 931 has the same structure as that of the processing unit 911 shown in FIG. 4. That is, the first processing 931 includes a first signal ordering unit 934, a gamma converter 935, a calculator 936, and a second signal ordering unit 937. Since the elements 934-937 of the first processing unit 931 are substantially the same as the elements 914-917 shown in FIG. 4, detailed description of the elements 934-937 is omitted.

The modifier 932 includes a calculator 940 and a luminance compensation variable determiner 941.

The calculator 940 receives the four color preliminary luminance signals LR, LG, LB, and LW from the first processing unit 931 and a luminance compensation variable “s” determined by the luminance compensation variable determiner 941. The calculator 940 modifies color temperature of the four color preliminary luminance signals LR, LG, LB, and LW, and compensates luminance of the four color preliminary luminance signals LR, LG, LB, and LW to generate the four color modification luminance signals LR′, LG′, LB′, and LW′. The luminance compensation variable determiner 941 determines the luminance compensation variable “s” based on the four color modification luminance signals LR′, LG′, LB′, and LW′.

At this time, the calculator 940 performs Equation 2 to generate the four color modification luminance signals LR′, LG′, LB′, and LW′.

$$( \begin{matrix}a + s & 0 & 0 & 0 \\ 0 & b + s & 0 & 0 \\ 0 & 0 & c + s & 0 \\ 0 & 0 & 0 & d + s\end{matrix} ) ( \begin{matrix}L R \\ L G \\ L B \\ L W\end{matrix} ) = ( \begin{matrix}L {P}^{′} \\ L {G}^{′} \\ L {B}^{′} \\ L {W}^{′}\end{matrix} ) \qquad ( Equation 2 )$$

In Equation 2, the characters a, b, c, and d are the color modification constants of red, green, blue and white, and the character s is the luminance compensation variable. The color modification constants a, b, c, and d may be defined as in the above description corresponding to Equation 1. The luminance compensation variable s is a variable for compensating the luminance of the four color preliminary luminance signals LR, LG, LB, and LW. As described, an initial value of the luminance compensation variable s is varied based on the four color modification luminance signals LR′, LG′, LB′, and LW′ from the calculator 940.

The luminance compensation variable determiner 941 determines the luminance compensation variable s as in the following description.

As described above, luminance of an output image is largely influenced by the image signal output to white pixels. In addition, when a value obtained by adding the color modification constant d of white and the luminance compensation variable s is more than 1, it means that luminance compensation may be excessive. Thereby, in one exemplary embodiment a magnitude of the luminance compensation variable s is determined to have the value obtained by adding the color modification constant d of white and the luminance compensation variable s, wherein the sum of s and d is substantially equal to or less than 1. However, in such an exemplary embodiment values obtained by adding the color luminance compensation variables a, b, and c of red, green and blue and the luminance compensation variable s may be more than 1.

By receiving the four color modification luminance signals LR′, LG′, LB′, and LW′ of a previous frame, the luminance compensation variable determiner 941 counts the number (herein after, referred to as “the excess number”) of the modification luminance signals LR′, LG′, LB′, and LW′, which have luminance more than a predetermined luminance, and defines the luminance compensation variable s based on the excess number. In one exemplary embodiment the predetermined luminance is a luminance (referred to as, “a maximum luminance”) represented by the maximum gray of the display device. When all of the modification luminance signals LR′, LG′, LB′, and LW′ of the input image signals R, G, and B included in one dot have the maximum luminance, the dot is said to have an excess number of 4. Thereby the excess number of one dot may be less than or equal to 4.

Thereafter, the excess numbers with respect to all the dots of the frame are added to obtain an excess number sum of the frame. When a value of the excess number sum is too large, it means that luminance compensation was performed more than needed, and when the value of the excess number sum is too small, it means that luminance compensation was not performed sufficiently. Thereby, in the present exemplary embodiment the value of the excess number sum is controlled to be within a predetermined range.

When the value of the excess sum is greater than the upper limit of the predetermined range, the luminance compensation variable s is defined as a value obtained by subtracting a predetermined value ΔS from a luminance compensation variable s of a previous frame, hereinafter referred to as “a previous luminance compensation variable”. However, when the value of the excess sum is less than the lower limit of the predetermined range, the luminance compensation variable s is defined as a value obtained by adding the predetermined value ΔS to the previous luminance compensation variable s. In one exemplary embodiment the upper and lower limits and the predetermined value ΔS may be obtained through experimentation.

The second processing unit 933 includes a clipping unit 938 and a de-gamma converter 939.

The clipping unit 938 receives the four color modification luminance signals LR′, LG′, LB′, and LW′ from the modifier 932. The clipping unit 938 modifies the four color modification luminance signals LR′, LG′, LB′, and LW′ having a luminance more than or equal to the maximum luminance to generate final luminance signals LR″, LG″, LB″, and LW′ of red, green, blue and white. In the present exemplary embodiment, the modification luminance signals LR′, LG′, LB′, and LW′ having a luminance less than the maximum luminance are output as the final luminance signals LR″, LG″, LB″, and LW′ without modification.

Luminances of the color modification luminance signals LR′, LG′, LB′, and LW′ having a luminance more than or equal to the maximum luminance are modified to have the maximum luminance. Thereby, luminances of all the final luminance signals LR″, LG″, LB″, and LW″ are represented in the display device.

The de-gamma converter 939 de-gamma converts the final luminance signals LR″, LG″, LB″, and LW′ to generate the output image signals (R′, G′, B′, and W′ of red, green, blue and white.

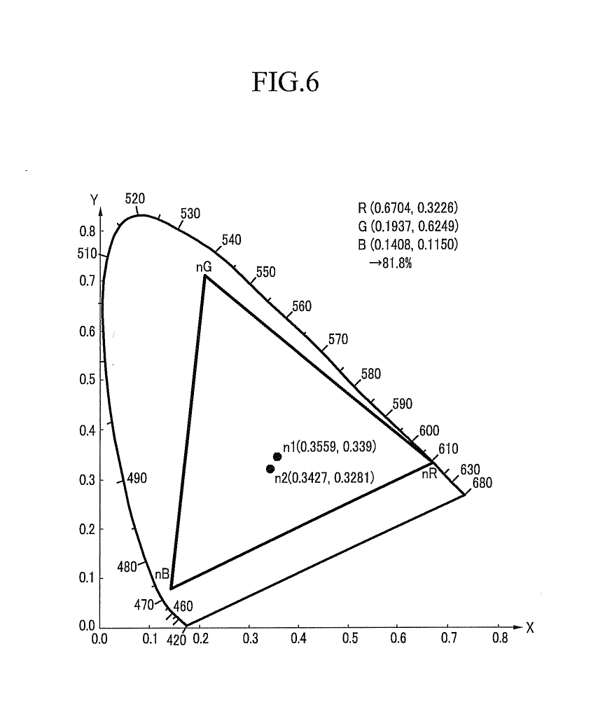

Next, referring to FIGS. 6 to 8, an exemplary embodiment of a conversion of color distribution according to the present invention will be described.

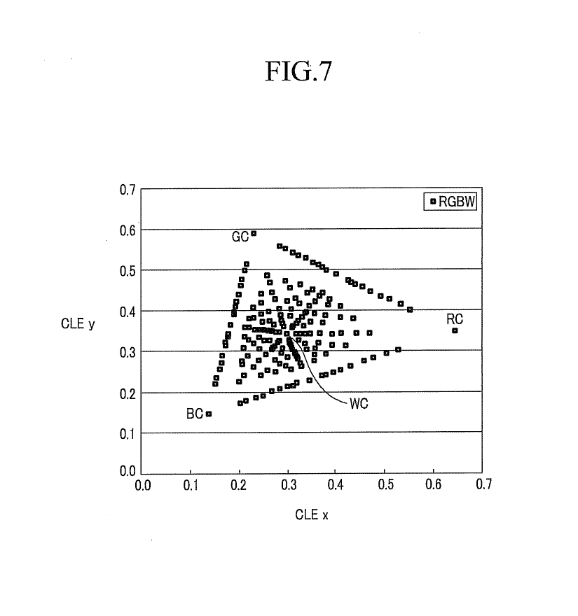

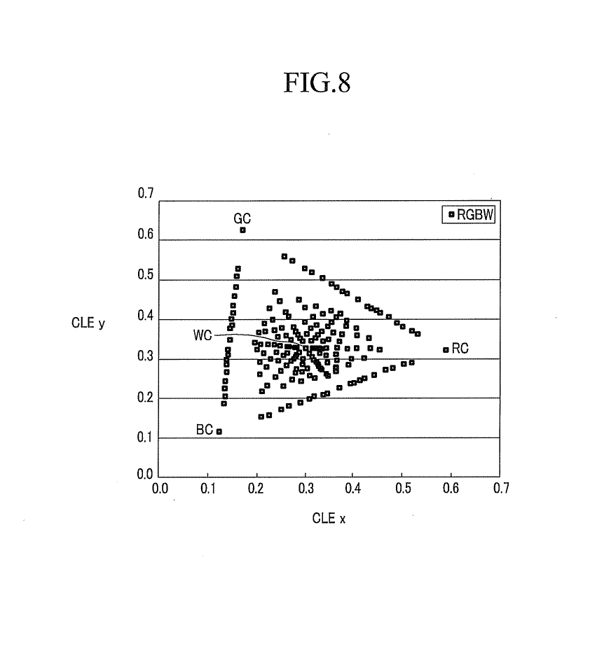

FIG. 6 shows a Commission Internationale de l'Eclairage (“CIE”) chromaticity diagram, FIG. 7 is a graph showing a color distribution according to a comparison display, and FIG. 8 is a graph showing a color distribution according to another exemplary embodiment of the present invention.

FIG. 6 shows a CIE chromaticity diagram representing x-axis and y-axis coordinates based on measured values obtained by a spectrophotometer. The x-axis and y-axis coordinates indicate color temperature, and the color temperature relates to properties of color, that is hue and saturation, other than luminance

A curved line having a horseshoe's shape in the chromaticity diagram in FIG. 6 is determined by obtaining color temperatures of monochromatic color light in each wavelength on the diagram and connecting the color temperatures with a line, and connecting color temperature points of pure purple and pure red to form the straight line across the bottom. All of the colors visible to the average human eye are represented in the curved line.

A triangle in the curved line having the horseshoe's shape defines a color range represented in a display device having three color pixels such as red, green and blue pixels, apexes nR, nG, and nB of the triangle indicate pure colors of red, green and blue.

In FIG. 6, a color temperature and a luminance of a synthesization white n1 and a color temperature and a luminance of a pixel white n2 are shown in

### Table 1.

TABLE 1

| | CIEₓ | CIE_{y} | Lv (Luminance) |
|---|---|---|---|
| n1 | 0.3559 | 0.3390 | 240.0 |
| n2 | 0.3427 | 0.3281 | 300.1 |

As shown in Table 1, the synthesization white has a color temperature and a luminance different from those of the pixel white.

As shown in FIG. 7, a color distribution based on conversion from three color image signals to four color image signals according to a comparison display includes three apexes that form a triangle. Each of the three apexes RC, GC, and BC represents red, green and blue, and the triangle represents boundaries of colors represented by mixtures of red, green and blue. That is, dots positioned on or within the boundaries of the triangle represent color distribution determined by the mixtures of red, green and blue. The center dot (referred to as “white apex”) WC of the color distribution represents white, and the dots spread in all directions from the white apex WC represent different mixes of the primary colors red, green and blue.

In such a comparative display, dots spread in certain directions from the white apex WC are formed not a straight line, but rather in a curved line. For example, dots sequentially spread from the white apex WC to the apex GC of the green do not form a straight line, but are curved from the white apex WC. In addition, dots sequentially spread from the white apex WC to the apex BC of blue and similarly from the white apex WC to the apex RC of red are curved from the white apex WC. Furthermore, distribution of all the dots are concentrated on the white apex WC. That is, distortion occurs throughout the entire color distribution.

FIG. 8 shows a color distribution in the exemplary embodiment of a display device according to the present invention as shown in FIG. 5.

In the exemplary embodiment of a display device according to the present invention as shown in FIG. 4, which has the synthesization white n1 and the pixel white n2 shown in Table 1, appropriate color modification constants a, b, c, and d obtained through several experiments were 0.85, 0.88, 1.0, and 0.7, respectively. In such an exemplary embodiment, all the color modification constants a, b, c, and d were less than or equal to about 1. In the exemplary embodiment of a display device according to the present invention as shown in FIG. 5, the luminance compensation variable s had a range from about −0.17 to about 0.17.

Referring to FIG. 8, dots spread in all directions from the white apex WC, and the dots spread in a pattern having a substantially straight line shape. That is, dots spread from the white apex WC towards particular color coordinates do so in a substantially straight line. For example, dots sequentially spread from the white apex WC to the apex GC of the green form a straight line. In addition, dots sequentially spread from the white apex WC to the apex BC of blue and from the white apex WC to the apex RC of red also form a straight line, respectively

Moreover, the concentration of dots around the white apex WC was reduced.

According to these exemplary embodiments, by using the color modification constants a, b, c, and d and the luminance compensation variable s, color error due to a color temperature difference between the pixel white and the synthesization white is reduced, without a reduction of the luminance of an image displayed by a display device.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a plurality of pixels which individually display one of a first color, a second color, a third color, and white;
a signal processor which receives input image signals corresponding to the first to third colors, modifies color temperatures represented by the input image signals, compensates luminances of the input image signals, and converts the input image signals corresponding to the first to third colors into output image signals corresponding to the first to third colors and white as a result of the modification and compensation; and
a data driver which converts the output image signals into data voltages and supplies the data voltages to the pixels.

2. The display device of claim 1, wherein the signal processor comprises:
a processing unit which generates preliminary luminance signals corresponding to the first to third colors, and white based on the input image signals;
a modifier which modifies the preliminary luminance signals based on a color modification value and generates modification luminance signals; and
a de-gamma converter which outputs the output image signals based on the modification luminance signals.

3. The display device of claim 2, wherein the modifier additionally modifies the preliminary luminance signals based on a luminance compensation value.

4. The display device of claim 3, wherein the luminance compensation value is defined by a luminance compensation variable, and wherein the luminance compensation variable is determined by the number of modification luminance signals of a previous frame having a luminance more than or equal to a maximum luminance of the display device.

5. The display device of claim 4, wherein when the number of modification luminance signals of a previous frame having a luminance more than or equal to a maximum luminance of the display device is within a predetermined range having an upper limit and a lower limit, the luminance compensation variable maintains a luminance compensation variable of the previous frame, and
wherein when the number of modification luminance signals of a previous frame having a luminance more than or equal to a maximum luminance of the display device is more than the upper limit, the luminance compensation variable is determined as a value obtained by subtracting a predetermined value from the luminance compensation variable of the previous frame, and
wherein when the number of modification luminance signals of a previous frame having a luminance more than or equal to a maximum luminance of the display device is less than the lower limit, the luminance compensation variable is determined as a value obtained by adding the predetermined value to the luminance compensation variable of the previous frame.

6. The display device of claim 4, wherein the modification luminance signals satisfies the equation below:
$$( \begin{matrix}a + s & 0 & 0 & 0 \\ 0 & b + s & 0 & 0 \\ 0 & 0 & c + s & 0 \\ 0 & 0 & 0 & d + s\end{matrix} ) ( \begin{matrix}L R \\ L G \\ L B \\ L W\end{matrix} ) = ( \begin{matrix}L {P}^{′} \\ L {G}^{′} \\ L {B}^{′} \\ L {W}^{′}\end{matrix} )$$
wherein, a, b, c, and d are color modification constants of the first to third colors and white, and the character s is the luminance compensation variable, LR, LG, LB, and LW are preliminary luminance signals of the first to third colors and white, and LR′, LG′, LB′, and LW′ are modification luminance signals of the first to third colors, and white.

7. The display device of claim 6, wherein a value obtained by adding the luminance compensation variable and the color modification constant of white is less than or equal to 1.

8. The display device of claim 2, wherein the signal processor defines a luminance of the preliminary luminance signal of white based on luminances of the input image signals, and determines luminances of the preliminary luminance signals of the first to third colors in accordance with the luminance of the preliminary luminance signal of white.

9. The display device of claim 8, wherein the luminance of the preliminary luminance signal of white is substantially equal to a minimum luminance value of the input image signals, and luminances of the preliminary luminance signals of the first to third colors are defined as values obtained by subtracting the luminance of the preliminary luminance signal of white from the luminances of the input image signals, respectively.

10. The display device of claim 9, wherein the signal processor de-gamma coverts the modification luminance signals to generate the output image signals, and
the signal processor defines the luminances of the modification luminance signals as a maximum luminance of the display device when the luminances of the modification luminance signals are greater than the maximum luminance of the display device, before the de-gamma conversion of the modification luminance signals.

11. The display device of claim 1, wherein each of the pixels comprises an organic light emitting element.

12. The display device of claim 1, wherein the first to third colors are three primary colors.

13. The display device of claim 12, wherein the primary colors are red, green and blue.

14. A method of driving a display device, the method comprising:
receiving red, green and blue input image signals;
generating preliminary luminance signals based on the input image signals;
modifying color temperatures of the preliminary luminance signals, and compensating luminances of the preliminary luminance signals to generate modification luminance signals of red, green, blue, and white; and
generating output image signals of red, green, blue and white based on the modification luminance signals,
wherein the luminance compensation of the preliminary luminance signals is performed based on the number of modification luminance signals of a previous frame having a luminance more than or equal to a maximum luminance of the display device.

15. The method of claim 14, wherein the preliminary luminance signal generation comprises:
aligning the input image signals sequentially from the input image signal having a largest magnitude gray voltage level to the input image signal having a smallest magnitude gray voltage level to generate first, second, and third signals, respectively;
defining the preliminary luminance signal of white to be substantially equal to a luminance corresponding to the third signal; and
modifying the input image signals based on the preliminary luminance signal of white to generate preliminary luminance signals of red, green and blue.

16. The method of claim 14, wherein the luminance compensation is defined by a luminance compensation variable, and
when the number of modification luminance signals of a previous frame having a luminance more than or equal to a maximum luminance of the display device is within a predetermined range having an upper limit and a lower limit, the luminance compensation variable maintains a luminance compensation variable of the previous frame,
when the number of modification luminance signals of a previous frame having a luminance more than or equal to a maximum luminance of the display device is more than the upper limit, the luminance compensation variable is determined as a value obtained by subtracting a predetermined value from the luminance compensation variable of the previous frame, and
when the number of modification luminance signals of a previous frame having a luminance more than or equal to a maximum luminance of the display device is less than the lower limit, the luminance compensation variable is determined as a value obtained by adding the predetermined value to the luminance compensation variable of the previous frame.

17. A method of driving a display device, the method comprising:
receiving red, green and blue input image signals;
generating preliminary luminance signals based on the input image signals;
modifying color temperatures of the preliminary luminance signals to generate modification luminance signals of red, green, blue, and white; and
generating output image signals of red, green, blue and white based on the modification luminance signals.
